(19) United States
(12) Patent Application Publication
(10) Pub. No.: US 2015/0002690 A1
(43) Pub. Date: Jan. 1, 2015

(54) IMAGE PROCESSING METHOD AND APPARATUS, AND ELECTRONIC DEVICE

(71) Applicant: Sony Corporation, Tokyo (JP)

(72) Inventors: Eric GE, Beijing (CN); Ian CUI, Beijing (CN)

(73) Assignee: Sony Corporation, Tokyo (JP)

(21) Appl. No.: 14/151,164

(22) Filed: Jan. 9, 2014

(30) Foreign Application Priority Data
Jul. 1, 2013 (CN) 201310271985.7

(51) Int. Cl. H04N 5/225; H04N 5/217; H04N 9/73; H04N 5/14; H04N 9/64; H04N 5/243; H04N 5/262

(52) U.S. Cl. CPC H04N 5/225; H04N 5/243; H04N 5/2173; H04N 5/2621; H04N 5/142; H04N 9/646; H04N 9/735
USPC 348/222.1

(57) ABSTRACT

The embodiments of the present invention provide an image processing method and apparatus, and an electronic device. The image processing method includes: acquiring an image containing a shot object with a shooting part; performing an image recognition of the acquired image to detect the shot object; acquiring image processing parameters of the detected shot object, wherein the image processing parameters are pre-stored according to the user's operation; and performing an image processing of the acquired image according to the image processing parameters of the shot object. Through the embodiments of the present invention, various personalized needs of the user can be met and better user experiences can be obtained.

### CROSS-REFERENCE TO RELATED APPLICATION AND PRIORITY CLAIM

This application claims priority from Chinese patent application No. 201310271985.7, filed Jul. 1, 2013, the entire disclosure of which hereby is incorporated by reference.

### TECHNICAL FIELD

The present invention relates to image processing technologies, and particularly, to an image processing method and apparatus, and an electronic device.

### BACKGROUND

With the development of technologies, more and more mobile terminals have the shooting function. For example, at present the smart phone, the digital camera, etc. have shooting parts to shoot people or sceneries, thereby generating static or dynamic images.

As used herein terms like shooting, shot, shot object, and so on are used equivalently and interchangeably with terms photographing or recording, e.g., as in recording a photograph or video as in digital photography, photographed or recorded, and photographed object or recorded object, and so on, respectively.

Currently, in order to obtain a better shooting effect, the mobile terminal can process an image after the image is generated. For example, a processing mode (black-and-white mode, dusk mode, etc.) can be selected to perform a simple processing of the image.

### SUMMARY

However, the image processing in the prior art can only use the processing mode preset by the manufacturer, and the image can just be processed according to one or several preset image processing parameters, thus various personalized needs of the user cannot be met, and better user experiences cannot be obtained.

To be noted, the above introduction to the technical background is just made for the convenience of clearly and completely describing the technical solutions of the present invention, and to facilitate the understanding of a person skilled in the art. It shall not be deemed that the above technical solutions are known to a person skilled in the art just because they have been illustrated in the Background section of the present invention.

The embodiments of the present invention provide an image processing method and apparatus, and an electronic device, for the purpose of meeting various individual needs of the user and obtaining better user experiences.

According to an aspect of embodiments of the present invention, an image processing method is provided, including:

acquiring an image containing a shot object with a shooting part (as will be appreciated, the terms “shot object” also may be referred to as a photographed object or photograph recorded object, and so on, and the terms “shooting part” may be referred to as a photographing or recording device, e.g., as a digital camera, video recorder and so on);

performing an image recognition of the acquired image to detect the shot object;

acquiring image processing parameters of the detected shot object, wherein the image processing parameters are pre-stored according to the user's operation; and

performing an image processing of the acquired image according to the image processing parameters of the shot object.

According to another aspect of embodiments of the present invention, the image processing method further includes:

generating the image processing parameters of the shot object according to the user's operation; and

storing the image processing parameters and an identifier of the shot object accordingly.

According to another aspect of embodiments of the present invention, the shot object is one or more portraits, or one or more objects.

According to another aspect of embodiments of the present invention, the image processing parameter includes one or arbitrary combinations of image brightness parameter, image chromaticity parameter, image saturation parameter, image white balance parameter, image de-noising processing parameter, feature removal or addition parameter, special effect processing parameter and edge enhancement processing parameter.

According to another aspect of embodiments of the present invention, the image processing method further includes:

acquiring information related to the image; and

determining image processing parameters for image processing according to the information related to the image and the acquired image processing parameters.

According to another aspect of embodiments of the present invention, the information related to the image includes one or arbitrary combinations of time information, weather information, shooting spot information, user information and history information.

According to another aspect of embodiments of the present invention, the image processing method further includes:

extracting feature information of the shot object; and

determining image processing parameters for image processing according to the extracted feature information and the acquired image processing parameters.

According to another aspect of embodiments of the present invention, the feature information of the shot object includes one or arbitrary combinations of hair style of the shot object, accessory of the shot object, scenario where the shot object is located, expression of the shot object, gesture of the shot object, clothing of the shot object, position of the shot object in the image, facial features of the shot object, skin color of the shot object and stature of the shot object.

According to another aspect of embodiments of the present invention, an image processing apparatus is provided, including:

a shooting unit, configured to acquire an image containing a shot object with a shooting part;

an image detection unit, configured to perform an image recognition of the acquired image to detect the shot object;

a parameter acquiring unit, configured to acquire image processing parameters of the detected shot object, wherein the image processing parameters are pre-stored according to the user's operation; and

an image processing unit, configured to perform an image processing of the acquired image according to the image processing parameters of the shot object.

According to another aspect of embodiments of the present invention, the image processing apparatus further includes:

a parameter generation unit, configured to generate the image processing parameters of the shot object according to the user's operation; and

a parameter storage unit, configured to store the image processing parameters and an identifier of the shot object accordingly.

According to another aspect of embodiments of the present invention, the image processing apparatus further includes:

an information acquiring unit, configured to acquire information related to the image; and

a first determination unit, configured to determines image processing parameters for image processing according to the information related to the image and the acquired image processing parameters.

According to another aspect of embodiments of the present invention, the image processing apparatus further includes:

a feature extraction unit, configured to extract feature information of the shot object; and

a second determination unit, configured to determine image processing parameters for image processing according to the extracted feature information and the acquired image processing parameters.

According to another aspect of embodiments of the present invention, an electronic device is provided, including the aforementioned image processing apparatus.

According to another aspect of embodiments of the present invention, the electronic device is a mobile terminal which shoots a shot object, the shot object being one or more portraits, or one or more objects.

The embodiments of the present invention have the beneficial effect that various personalized needs of the user can be met and better user experiences can be obtained by acquiring, during a shooting, image processing parameters corresponding to the shot object and pre-stored according to the user's operation, and performing an image processing of the acquired image according to the image processing parameters corresponding to the shot object.

These and other aspects of the present invention will be clear with reference to the following descriptions and drawings. In those descriptions and drawings, the embodiments of the present invention are disclosed to represent some manners for implementing the principle of the present invention. But it shall be appreciated that the scope of the present invention is not limited thereto. On the contrary, the present invention includes all changes, modifications and equivalents falling within the scope of the spirit and the connotation of the accompanied claims.

Features described and/or illustrated with respect to one embodiment can be used in one or more other embodiments in a same or similar way, and/or combine with or replace the features in other embodiments.

To be noted, the term “comprise/include” used herein specifies the presence of feature, integer, step or component, not excluding the presence or addition of one or more other features, integers, steps or components.

Many aspects of the present invention can be understood better with reference to the following drawings. The components in the drawings are not necessarily in proportion, and the emphasis lies in clearly illustrating the principles of the present invention. For the convenience of illustrating and describing some portions of the present invention, corresponding portions in the drawings may be enlarged, e.g., being enlarged in relation to other portions in an exemplary device practically manufactured according to the present invention. The parts and features described in one drawing or embodiment of the present invention may be combined with the parts and features illustrated in one or more other drawings or embodiments. In addition, the same reference signs denote corresponding portions throughout the drawings, and they can be used to denote the same or similar portions in more than one embodiment.

### BRIEF DESCRIPTION OF THE DRAWINGS

The included drawings are provided for further understanding of the present invention, and they constitute a portion of the Specification. The drawings illustrate the preferred embodiments of the present invention, and they are used to explain the principles of the present invention together with the text, wherein the same element is always denoted with the same reference sign.

In which:

FIG. 1 is a flowchart of an image processing method according to Embodiment 1 of the present invention;

FIG. 2 is a schematic diagram of a user avatar (personification or image) before being processed according to Embodiment 1 of the present invention;

FIG. 3 is a schematic diagram of a user avatar (personification or image) after being processed according to Embodiment 1 of the present invention;

FIG. 4 is a schematic diagram of a hand image before being processed according to Embodiment 1 of the present invention;

FIG. 5 is a schematic diagram of a hand image after being processed according to Embodiment 1 of the present invention;

FIG. 6 is a flowchart of an image processing method according to Embodiment 2 of the present invention;

FIG. 7 is another flowchart of an image processing method according to Embodiment 2 of the present invention;

FIG. 8 is another flowchart of an image processing method according to Embodiment 2 of the present invention;

FIG. 9 is another flowchart of an image processing method according to Embodiment 2 of the present invention;

FIG. 10 is a structure or system diagram of an image processing apparatus according to Embodiment 3 of the present invention;

FIG. 11 is a structure or system diagram of an image processing apparatus according to Embodiment 4 of the present invention;

FIG. 12 is another structure or system diagram of an image processing apparatus according to Embodiment 4 of the present invention;

FIG. 13 is another structure or system diagram of an image processing apparatus according to Embodiment 4 of the present invention;

FIG. 14 is another structure or system diagram of an image processing apparatus according to Embodiment 4 of the present invention; and

FIG. 15 is a block diagram of a system structure of a mobile terminal according to Embodiment 5 of the present invention.

### DESCRIPTION OF THE EMBODIMENTS

The interchangeable terms “electronic device” and “electronic apparatus” include a portable radio communication device. The term “portable radio communication device”, which is hereinafter referred to as “mobile radio terminal”, “portable electronic apparatus”, or “portable communication apparatus”, includes all devices such as mobile phone, pager, communication apparatus, electronic organizer, personal digital assistant (PDA), smart phone, portable communication apparatus or the like.

In the present application, the embodiments are mainly described with respect to a portable electronic apparatus in the form of a mobile phone (also referred to as “cellular phone”). However, it shall be appreciated that the present invention is not limited to the case of the mobile phone and it may relate to any type of appropriate electronic device, such as media player, gaming device, PDA, computer, digital camera, tablet PC, etc.

### Embodiment 1

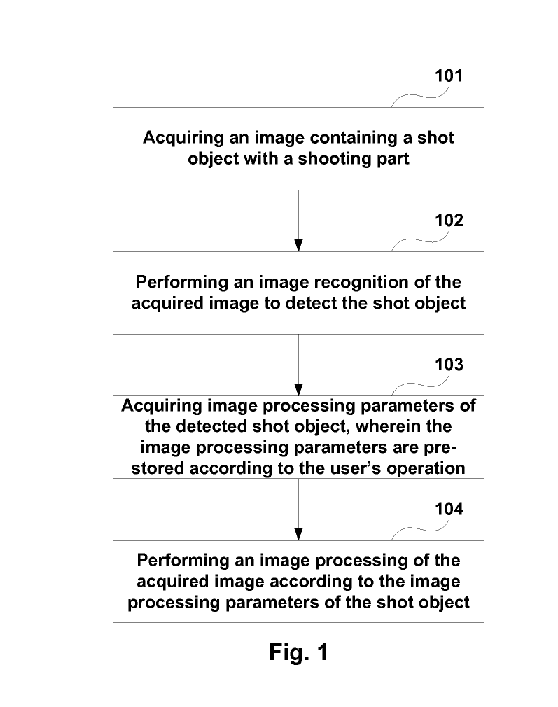

The embodiment of the present invention provides an image processing method. FIG. 1 is a flowchart of an image processing method according to Embodiment 1 of the present invention. As illustrated in FIG. 1, the image processing method includes:

Step 101: acquiring an image containing a shot object (photographed object) with a shooting part (camera or image recorder);

Step 102: performing an image recognition of the acquired image to detect the shot object;

Step 103: acquiring image processing parameters of the detected shot object, where the image processing parameters are pre-stored according to the user's operation;

Step 104: performing an image processing of the acquired image according to the image processing parameters of the shot object.

In this embodiment, the image processing method may be applied in electronic devices such as a mobile terminal and a digital camera, and the shooting part for example may be a camera in the mobile terminal. The shot object may be one or more faces, portraits (i.e., including face or other portions of the human body) or objects, but the present invention is not limited thereto. For example, the shot object may also be other object such as scenery, and it can be specifically determined upon the actual condition. The faces or portraits are just taken as examples for detailed descriptions of the present invention.

In this embodiment, an image recognition of the acquired image may be performed to detect the shot object, e.g., a face recognition processing may be performed to acquire the identification information of the face. For the specific content of the image recognition or the face recognition, please refer to the prior art.

In this embodiment, information of the shot object may be pre-registered (pre-recorded or stored), for example, the identification information of the shot object may be pre-stored in correspondence with one or more image processing parameters, where the one or more image processing parameters are pre-generated according to the user's operation.

The image processing parameters may include one or arbitrary combinations of image brightness parameter, image chromaticity parameter, image saturation parameter, image white balance parameter, image de-noising processing parameter, feature removal or addition parameter, special effect processing parameter, edge enhancement processing parameter, etc.

In this embodiment, after the image processing parameters corresponding to the shot object are obtained, an image processing of the acquired image may be performed according to the image processing parameters. For the specific image processing according to the image processing parameters, please refer to the prior art.

Next, the image processing parameters are described by using an example. Table 1 shows a specific example of the pre-stored shot object and the image processing parameters, and schematically illustrates the condition of the image processing parameters. As shown in Table 1, shot object 1 may be a head portrait of user 1, and corresponding image processing parameters are: brightness parameter=B3, de-noising processing parameter=G4, and feature removal parameter=ZM (22,45). Shot object 2 may be a hand portrait of user 2, and corresponding image processing parameters are: brightness parameter=B1, de-noising processing parameter=G2, and special processing parameter=star.

TABLE 1

| No. | Shot Object | Parameter |
|---|---|---|
| 1 | Head of user 1 | Brightness parameter = B3; |
| | | De-noising processing parameter = G4; |
| | | Feature removal parameter = ZM (22, 45) |
| 2 | Hand of user 2 | Brightness parameter = B1; |
| | | De-noising processing parameter = G2; |
| | | Special processing parameter = star |
| 3 | Face of user 3 | Chromaticity parameter = S1 |
| | | Feature removal parameter = ZM (10, 40) |
| | | Edge enhancement processing parameter = Yes |
| . . . | . . . | . . . |

In one embodiment, when a head of user 1 is shot, the shot object may be recognized according to the image recognition technology, and the image processing parameters corresponding to the shot object may be found as follows according to the identification information of the shot object: brightness parameter=B3 (e.g., indicating that the brightness is increased by 3 levels), de-noising processing parameter=G4 (e.g., there are 5 de-noising processing grades, and this processing is of grade 4), and feature removal parameter=ZM (22,45) (e.g., indicating to remove a nevus having position coordinates (22,45), where for example a nose tip in the face is taken as the origin of coordinates). Thus, an image processing of the head of user 1 is performed according to the image processing parameters corresponding to the shot object.

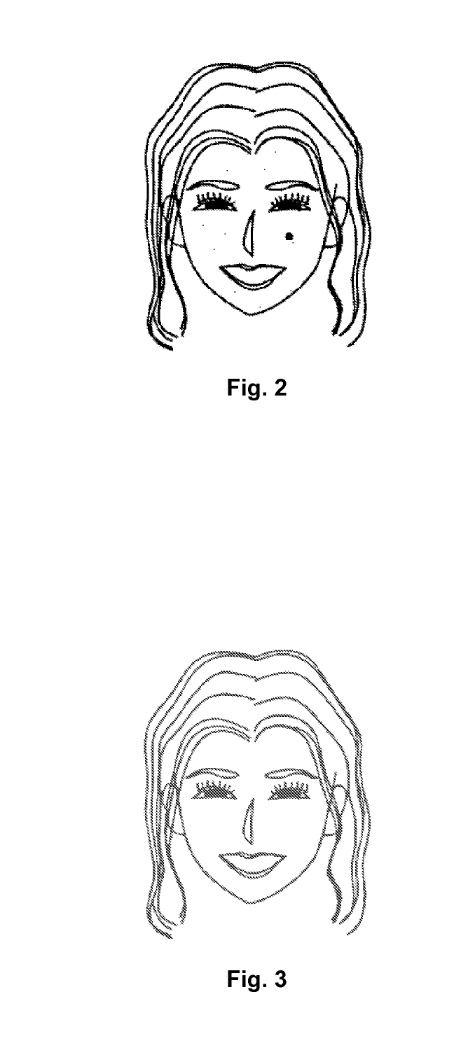

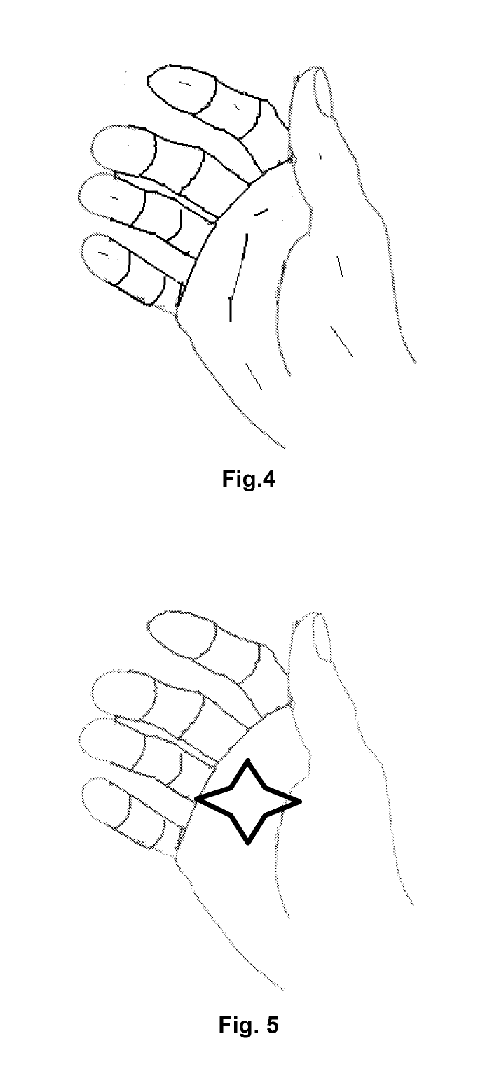

FIG. 2 is a schematic diagram of a user head portrait before being processed according to the embodiment of the present invention, and FIG. 3 is a schematic diagram of the user head portrait after being processed according to the embodiment of the present invention. As illustrated in FIG. 2, the face is coarse before being processed, and it has a freckle or a nevus thereon. As illustrated in FIG. 3, the face image is smoother after the brightness increase and the de-noising processing, and the nevus on the face is removed by using the feature removal parameter, thus the shot image is personalized to obtain a face image satisfied by the user.

In another embodiment, when a hand of user 2 is shot, the shot object may be recognized according to the image recognition technology, and the image processing parameters corresponding to the shot object may be found as follows according to the identification information of the shot object: brightness parameter=B1 (e.g., indicating that the brightness is increased by 1 level), de-noising processing parameter=G2 (e.g., there are 5 de-noising processing grades, and this processing is of grade 2), and special processing parameter=star (e.g., indicating to add a start shape at the image center). Thus, an image processing of the hand of user 2 is performed according to the image processing parameters corresponding to the shot object.

FIG. 4 is a schematic diagram of a hand image before being processed according to the embodiment of the present invention, and FIG. 5 is a schematic diagram of the hand image after being processed according to the embodiment of the present invention. As illustrated in FIG. 4, the hand is coarse before being processed. As illustrated in FIG. 5, the hand image is smoother after the brightness increase and the de-noising processing, and new features may be added to the originally shot image by using a special effect parameter, thus the shot image is personalized to obtain a more special effect.

In another embodiment, when a face of user 3 is shot, the shot object may be recognized according to the image recognition technology, and the image processing parameters corresponding to the shot object may be found as follows according to the identification information of the shot object: chromaticity parameter=S1 (e.g., indicating that the chromaticity is increased by 1 level), feature removal parameter=ZM (10, 40) (e.g., indicating to remove a nevus having position coordinates (10, 40), where for example a nose tip in the face is taken as the origin of coordinates), and edge enhancement processing parameter=Yes (e.g., indicating to perform an enhancement processing of the edge or outline of detected shot object). Thus, an image processing of the face of user 3 is performed according to the image processing parameters corresponding to the shot object.

To be noted, the present invention is just an example described as above using the image processing parameters in Table 1. But the present invention is not limited thereto, and other parameters may be used.

In this embodiment, different from the prior art, the image processing parameters are generated according to the user's operation, thus the processing parameters can be freely generated according to the user's personal preference, so as to meet various personalized needs of the user. In addition, by pre-storing the image processing parameters, an image processing may be automatically performed when the shot object is recognized, without requiring the user's participation again, thereby quickly presenting the user-satisfied image.

As can be seen from the above embodiment, various personalized needs of the user can be met and better user experiences can be obtained by acquiring, during a shooting, image processing parameters corresponding to the shot object and pre-stored according to the user's operation, and performing an image processing of the acquired image according to the image processing parameters corresponding to the shot object.

### Embodiment 2

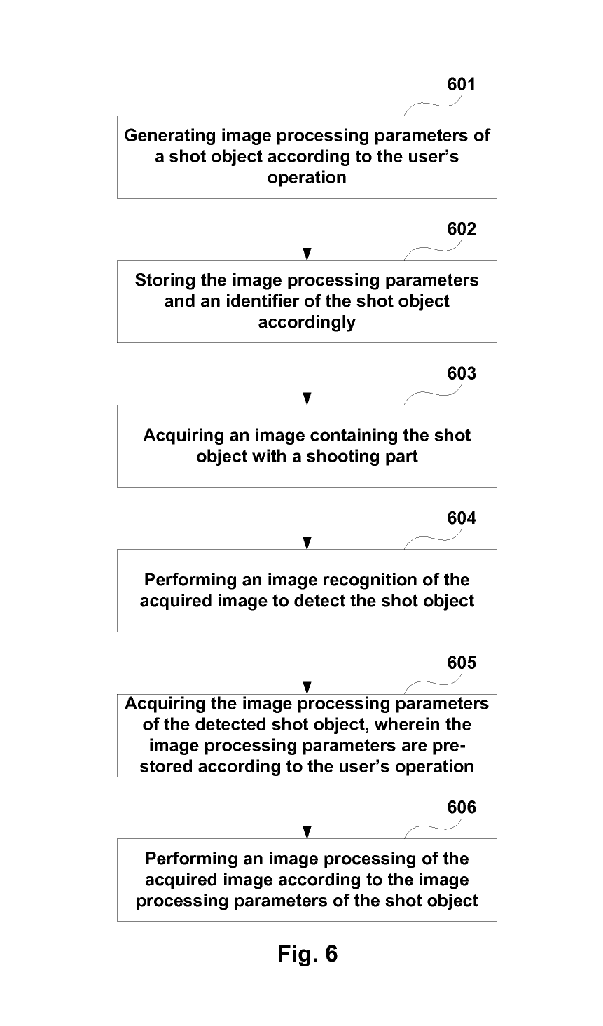

On the basis of Embodiment 1, the embodiment of the present invention provides an image processing method to make further descriptions of the present invention. FIG. 6 is a flowchart of an image processing method according to the embodiment of the present invention. As illustrated in FIG. 6, the image processing method includes:

Step 601: generating image processing parameters of a shot object according to the user's operation.

Step 602: storing the image processing parameters and an identifier of the shot object accordingly.

Step 603: acquiring an image containing the shot object with a shooting part.

Step 604: performing an image recognition of the acquired image to detect the shot object.

Step 605: acquiring the image processing parameters of the detected shot object, where the image processing parameters are pre-stored according to the user's operation.

Step 606: performing an image processing of the acquired image according to the image processing parameters of the shot object.

In this embodiment, the user may select the image processing parameters corresponding to the shot object after the shot object is initially shot, thereby generating the image processing parameters corresponding to the shot object. For example, the user may select various parameters by using a man-machine interaction interface, and then store the selected various parameters.

Or, the user may establish various rules and conditions, without selecting parameters after shooting the object. For example, it may be specified that the brightness is increased by 1 level for any face image. In addition, the user may set different image processing parameters for a plurality of shot objects, and process each shot object with different image processing parameters.

The storage of the image processing parameters is schematically described as above. In the implementation, based on the pre-stored image processing parameters, the image processing may be performed according to more information, so as to further meet the user's personalized needs. Next, descriptions will be made by taking the information related to the image and the feature information of the shot object as an example.

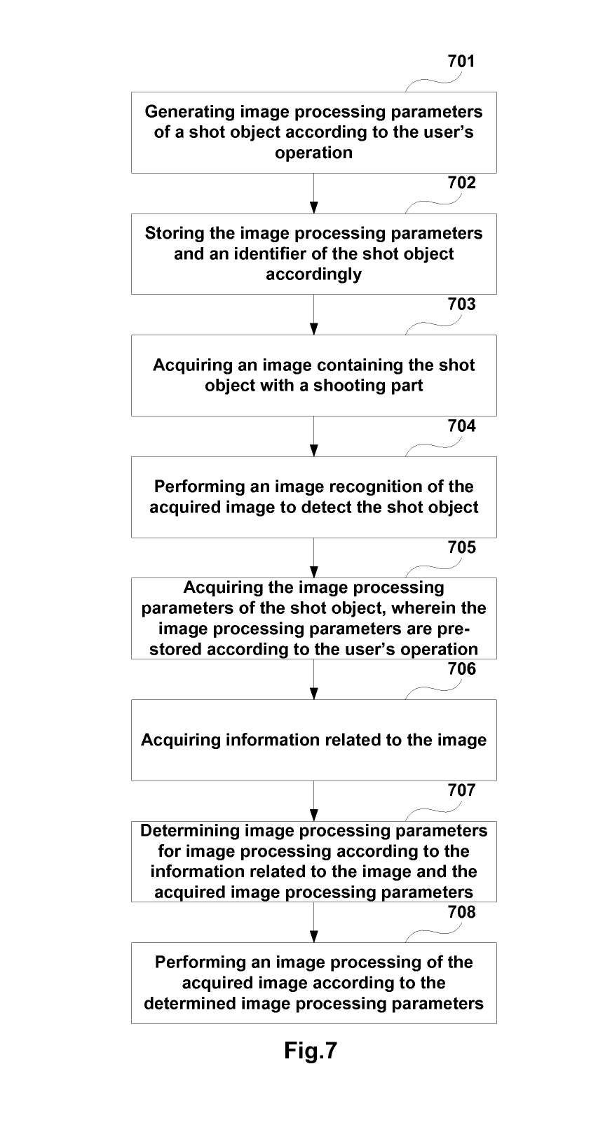

FIG. 7 is another flowchart of an image processing method according to the embodiment of the present invention. As illustrated in FIG. 7, the image processing method includes:

Step 701: generating image processing parameters of a shot object according to the user's operation.

Step 702: storing the image processing parameters and an identifier of the shot object accordingly.

Step 703: acquiring an image containing the shot object with a shooting part.

Step 704: performing an image recognition of the acquired image to detect the shot object.

Step 705: acquiring the image processing parameters of the shot object, where the image processing parameters are pre-stored according to the user's operation.

Step 706: acquiring information related to the image.

Step 707: determining image processing parameters for image processing according to the information related to the image and the acquired image processing parameters.

Step 708: performing an image processing of the acquired image according to the determined image processing parameters.

In this embodiment, the information related to the image for example may be the information acquired outside the image, and may include one or arbitrary combinations of time information, weather information, shooting spot information, user information and history information. But the present invention is not limited thereto, and any other related information may also be included. In addition, step 706 is not limited to be after step 705, and it may be performed at any time before step 707.

In step 707, based on the pre-stored image processing parameters, one or more image processing parameters may be added according to the information related to the image, so as to determine the image processing parameters for image processing. Or, the pre-stored image processing parameters may be transformed according to the information related to the image (e.g., amending a value of an image processing parameter, deleting a certain image processing parameter, etc.). The specific implementation may be determined upon the actual condition.

In one embodiment, the time information of shooting the image of the shot object can be acquired directly from a time module of the mobile terminal, or acquired from a server side via a communication network. For the specific acquisition of the time information, please refer to the prior art.

For example, if the acquired time information is Monday, it means that the user is in a bad mood because he begins to work. Thus in step 707, based on the image processing parameters corresponding to the shot object, the image brightness may be decreased by 2 levels according to the time information to indicate the bad mood. For another example, if the acquired time information is Friday, it means that the user is in a good mood because the weekend is coming. Thus in step 707, based on the image processing parameters corresponding to the shot object, the image brightness may be increased by 2 levels according to the time information to indicate the good mood.

In another embodiment, the weather information of shooting the image of the shot object can be acquired directly from a weather module of the mobile terminal, or acquired from a server side via a communication network. For the specific acquisition of the weather information, please refer to the prior art.

For example, if the acquired weather information is rainy, it means that the user is in a bad mood because of the rainy day. Thus in step 707, based on the image processing parameters corresponding to the shot object, the image chromaticity may be decreased by 2 levels according to the weather information to indicate the bad mood. For another example, if the acquired weather information is sunny, it means that the user is in a good mood because of the sunny day. Thus in step 707, based on the image processing parameters corresponding to the shot object, the image chromaticity may be increased by 2 levels according to the weather information to indicate the good mood.

In another embodiment, the shooting spot information of shooting the image of the shot object can be acquired directly from a positioning module (e.g., GPS module) of the mobile terminal, or acquired from a server side via a communication network. For the specific acquisition of the shooting spot information, please refer to the prior art.

For example, if the acquired shooting spot information is at home, it means that the user is in a relaxed mood. Thus in step 707, based on the image processing parameters corresponding to the shot object, the image saturation may be decreased by 2 levels according to the shooting spot information. For another example, if the acquired shooting spot information is in the office, it means that the user is in a nervous mood. Thus in step 707, based on the image processing parameters corresponding to the shot object, the image saturation may be increased by 2 levels according to the shooting spot information.

In another embodiment, the user information of shooting the image of the shot object can be acquired directly from the user registration information of the mobile terminal, e.g., the gender, age, etc. of the user of the mobile terminal may be acquired.

For example, if the acquired user information is young women, then in step 707, based on the image processing parameters corresponding to the shot object, the de-noising processing parameter may be changed according to the user information so that the image is smoother. For another example, if the acquired user information is old man, then in step 707, based on the image processing parameters corresponding to the shot object, no de-noising processing needs to be further performed according to the user information.

In another embodiment, the history information related to the shot object, such as information indicating user preference, can be acquired directly from a history information database stored by the mobile terminal.

For example, if the acquired history information is “for the picture where the shot object is a portrait, the user performs edge enhancement processing of 9 in 10 portrait pictures”, then in step 707, based on corresponding image processing parameters, the edge enhancement processing parameter may be added according to the history information, in a case where the shot object is a portrait.

Therefore, the various personalized needs of the user can be further met and better user experiences can be obtained by acquiring the information related to the image, and performing an image processing of the acquired image according to the information related to the image and the image processing parameters corresponding to the shot object.

The acquisition of the information related to the image is schematically described as above. In addition, the image may be further processed according to the features of the image or the shot object.

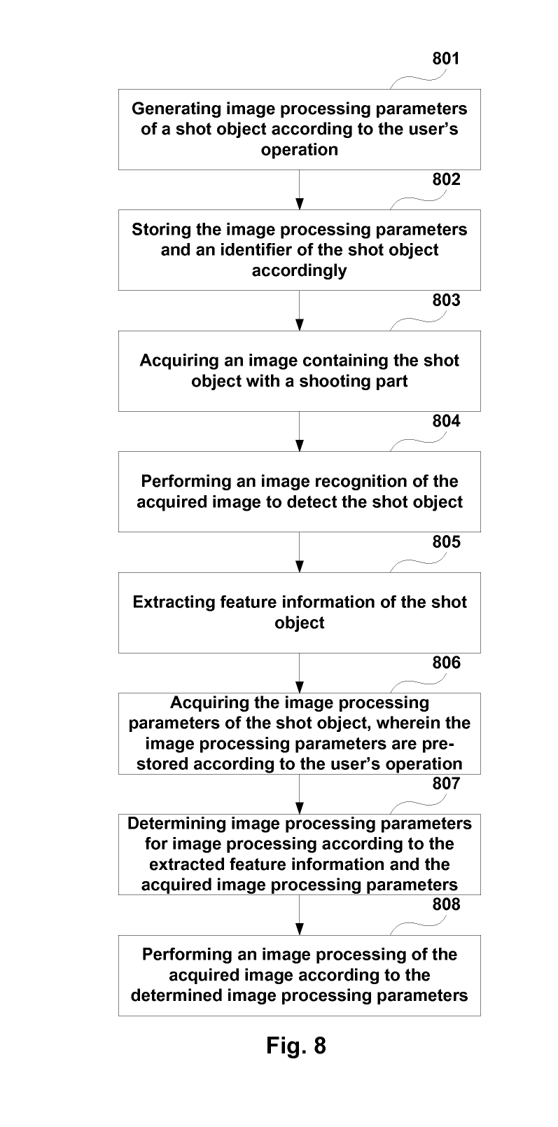

FIG. 8 is another flowchart of an image processing method according to the embodiment of the present invention. As illustrated in FIG. 8, the image processing method includes:

Step 801: generating image processing parameters of a shot object according to the user's operation.

Step 802: storing the image processing parameters and an identifier of the shot object accordingly.

Step 803: acquiring an image containing the shot object with a shooting part.

Step 804: performing an image recognition of the acquired image to detect the shot object.

Step 805: extracting feature information of the shot object.

Step 806: acquiring the image processing parameters of the shot object, where the image processing parameters are pre-stored according to the user's operation;

Step 807: determining image processing parameters for image processing according to the extracted feature information and the acquired image processing parameters.

Step 808: performing an image processing of the acquired image according to the determined image processing parameters.

In this embodiment, step 804 and step 805 may be performed at the same time, an image recognition of the acquired image may be performed using the image recognition technology, and the feature information of the shot object may be extracted while the shot object is detected. For the specific detection and extraction, please refer to the prior art.

The feature information of the shot object may include one or arbitrary combinations of hair style of the shot object, accessory of the shot object, scenario where the shot object is located, expression of the shot object, gesture of the shot object and clothing of the shot object. But the present invention is not limited thereto, and other feature information of the shot object may also be used, such as facial features (five sense organs) of the shot object, skin color of the shot object, stature of the shot object, etc. The feature information of the shot object may be acquired using the image recognition technology. For the specific implementation, please refer to the prior art, and herein is omitted.

In one embodiment, the feature information of the shot object may be the hair style of the shot object. For example, if the hair style of the shot object is long hair, it means that the user is in a relaxed mood, then in step 807, based on the image processing parameters corresponding to the shot object, the image saturation may be decreased by 1 level according to the feature information. For another example, if the hair style of the shot object is short hair, it means that the user is in a nervous mood, then in step 807, based on the image processing parameters corresponding to the shot object, the image saturation may be increased by 1 level according to the feature information.

In another embodiment, the feature information of the shot object may be the accessory of the shot object. For example, if the accessory of the shot object is sunglasses, it means that the user is in a relaxed mood, then in step 807, based on the image processing parameters corresponding to the shot object, the image saturation may be increased by 1 level according to the feature information. For another example, if the accessory of the shot object is a golden frame glasses, it means that the user is in a nervous mood, then in step 807, based on the image processing parameters corresponding to the shot object, the image saturation may be decreased by 1 level according to the feature information.

In another embodiment, the feature information of the shot object may be the scenario where the shot object is located. For example, if the scenario where the shot object is located is indoors, then in step 807, based on the image processing parameters corresponding to the shot object, the image brightness may be increased by 1 level according to the feature information. For another example, if the scenario where the shot object is located is outdoors, then in step 807, based on the image processing parameters corresponding to the shot object, the image brightness may be decreased by 1 level according to the feature information.

In another embodiment, the feature information of the shot object may be expression of the shot object. For example, if the expression of the shot object is smiling, it means that the user is in a relaxed mood, then in step 807, based on the image processing parameters corresponding to the shot object, the image brightness may be increased by 1 level according to the feature information. For another example, if the expression of the shot object is serious, it means that the user is in a nervous mood, then in step 807, based on the image processing parameters corresponding to the shot object, the image brightness may be decreased by 1 level according to the feature information.

In another embodiment, the feature information of the shot object may be the gesture of the shot object. For example, if the gesture of the shot object is a “V” shape, it means that the user is in a relaxed mood, then in step 807, based on the image processing parameters corresponding to the shot object, the image brightness may be increased by 1 level according to the feature information. For another example, if the gesture of the shot object is a fist, it means that the user is in a nervous mood, then in step 807, based on the image processing parameters corresponding to the shot object, the image brightness may be decreased by 1 level according to the feature information.

In another embodiment, the feature information of the shot object may be the clothing of the shot object. For example, if the clothing of the shot object is casual, it means that the user is in a relaxed mood, then in step 807, based on the image processing parameters corresponding to the shot object, the image brightness may be increased by 1 level according to the feature information. For another example, if the clothing of the shot object is formal, it means that the user is in a nervous mood, then in step 807, based on the image processing parameters corresponding to the shot object, the image brightness may be decreased by 1 level according to the feature information.

In another embodiment, the feature information of the shot object may be the position of the shot object in the image. For example, if the detected shot object is at the central position of the image, then in step 807, based on the image processing parameters corresponding to the shot object, an edge enhancement processing parameter of the shot object may be added according to the feature information. For another example, if the detected shot object is not at the central position of the image, then in step 807, no edge enhancement processing needs to be performed according to the feature information.

In addition, if a plurality of shot objects are detected (e.g., there are multiple faces) and the detected shot objects are at the central position of the image, then in step 807, a middle one is further selected from the plurality of shot objects according to the feature information, i.e., the position of the shot object in the image, next, based on the image processing parameters corresponding to respective shot objects, an edge enhancement processing parameter is added for the middle shot object.

To be noted, the acquisition of the information related to the image and the feature information of the shot object are schematically described above respectively, but the present invention is not limited thereto. In addition, the two types of information may be used in a combination.

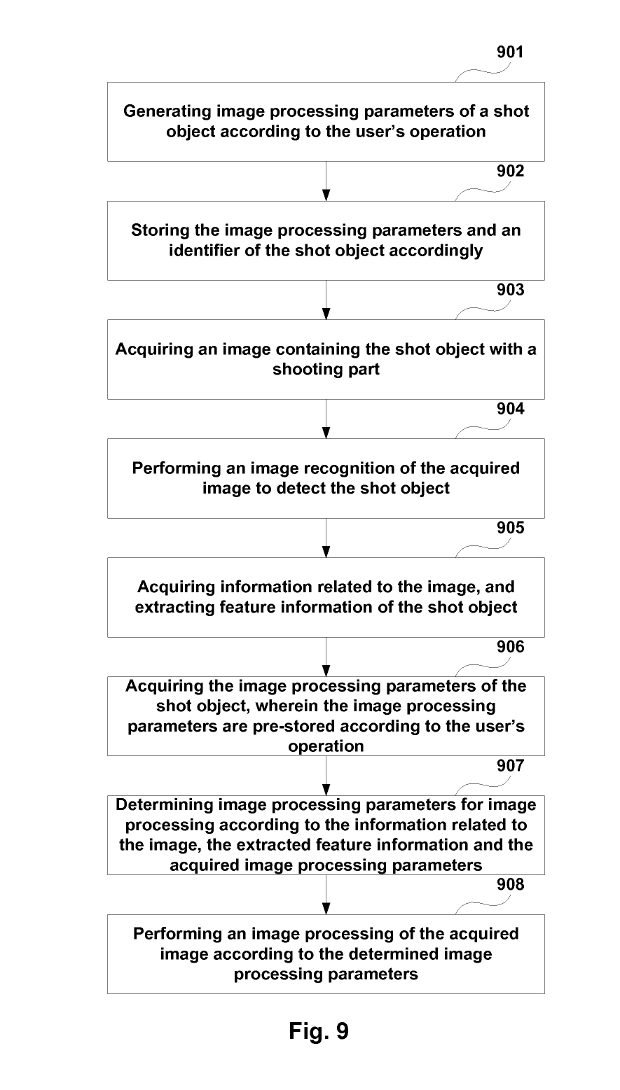

FIG. 9 is another flowchart of an image processing method according to the embodiment of the present invention. As illustrated in FIG. 9, the image processing method includes:

Step 901: generating image processing parameters of a shot object according to the user's operation.

Step 902: storing the image processing parameters and an identifier of the shot object accordingly.

Step 903: acquiring an image containing the shot object with a shooting part.

Step 904: performing an image recognition of the acquired image to detect the shot object.

Step 905: acquiring information related to the image, and extracting feature information of the shot object.

Step 906: acquiring the image processing parameters of the shot object, where the image processing parameters are pre-stored according to the user's operation;

Step 907: determining image processing parameters for image processing according to the information related to the image, the extracted feature information and the acquired image processing parameters.

Step 908: performing an image processing of the acquired image according to the determined image processing parameters.

As can be seen from the above embodiment, various personalized needs of the user can be met and better user experiences can be obtained by acquiring, during a shooting, image processing parameters corresponding to the shot object and pre-stored according to the user's operation, and performing an image processing of the acquired image according to the image processing parameters corresponding to the shot object.

### Embodiment 3

The embodiment of the present invention provides an image processing apparatus, which is corresponding to the image processing method in Embodiment 1, and the same contents are omitted herein.

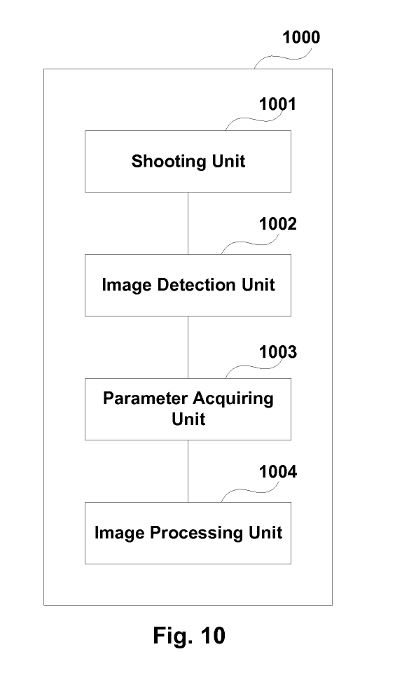

FIG. 10 is a structure diagram of an image processing apparatus according to the embodiment of the present invention. As illustrated in FIG. 10, the image processing apparatus 1000 includes a shooting unit 1001, an image detection unit 1002, a parameter acquiring unit 1003 and an image processing unit 1004. For other portions of the image processing apparatus 1000, please refer to the prior art.

The shooting unit 1001 acquires an image containing a shot object with a shooting part; the image detection unit 1002 performs an image recognition of the acquired image to detect the shot object; the parameter acquiring unit 1003 acquires image processing parameters of the detected shot object, where the image processing parameters are pre-stored according to the user's operation; and the image processing unit 1004 performs an image processing of the acquired image according to the image processing parameters of the shot object.

In this embodiment, the image processing parameter may include one or arbitrary combinations of image brightness parameter, image chromaticity parameter, image saturation parameter, image white balance parameter, image de-noising processing parameter, feature removal or addition parameter, special effect processing parameter, edge enhancement processing parameter, etc.

As can be seen from the above embodiment, various personalized needs of the user can be met and better user experiences can be obtained by acquiring, during a shooting, image processing parameters corresponding to the shot object and pre-stored according to the user's operation, and performing an image processing of the acquired image according to the image processing parameters corresponding to the shot object.

### Embodiment 4

The embodiment of the present invention provides an image processing apparatus, which is corresponding to the image processing method in Embodiment 2, and the same contents are omitted herein.

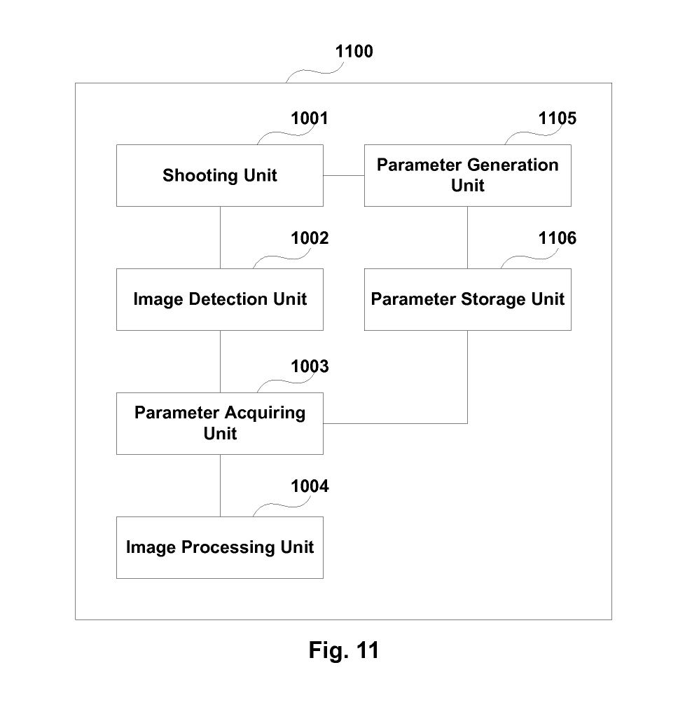

FIG. 11 is a structure diagram of an image processing apparatus according to the embodiment of the present invention. As illustrated in FIG. 11, the image processing apparatus 1100 includes a shooting unit 1001, an image detection unit 1002, a parameter acquiring unit 1003 and an image processing unit 1004, as described in Embodiment 3.

As illustrated in FIG. 11, the image processing apparatus 1100 may further include a parameter generation unit 1105 and a parameter storage unit 1106. The parameter generation unit 1105 generates the image processing parameters of the shot object according to the user's operation, and the parameter storage unit 1106 stores the image processing parameters and an identifier of the shot object accordingly.

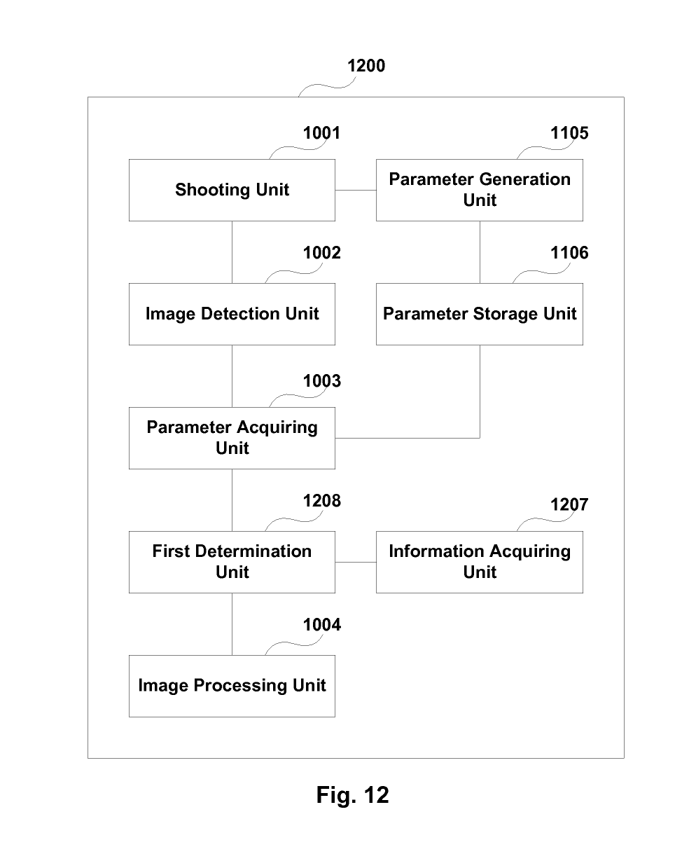

FIG. 12 is another structure diagram (or system diagram) of an image processing apparatus according to an embodiment of the present invention. As illustrated in FIG. 12, the image processing apparatus 1200 includes a shooting unit 1001, an image detection unit 1002, a parameter acquiring unit 1003, an image processing unit 1004, a parameter generation unit 1105 and a parameter storage unit 1106, as described above.

As illustrated in FIG. 12, the image processing apparatus 1200 may further include an information acquiring unit 1207 and a first determination unit 1208, where the information acquiring unit 1207 acquires information related to the image, and the first determination unit 1208 determines image processing parameters for image processing according to the information related to the image and the acquired image processing parameters. In addition, the image processing unit 1004 is further configured to perform an image processing of the acquired image according to the image processing parameters determined by the first determination unit 1208.

In this embodiment, the information related to the image may include one or arbitrary combinations of time information, weather information, shooting spot information and user information.

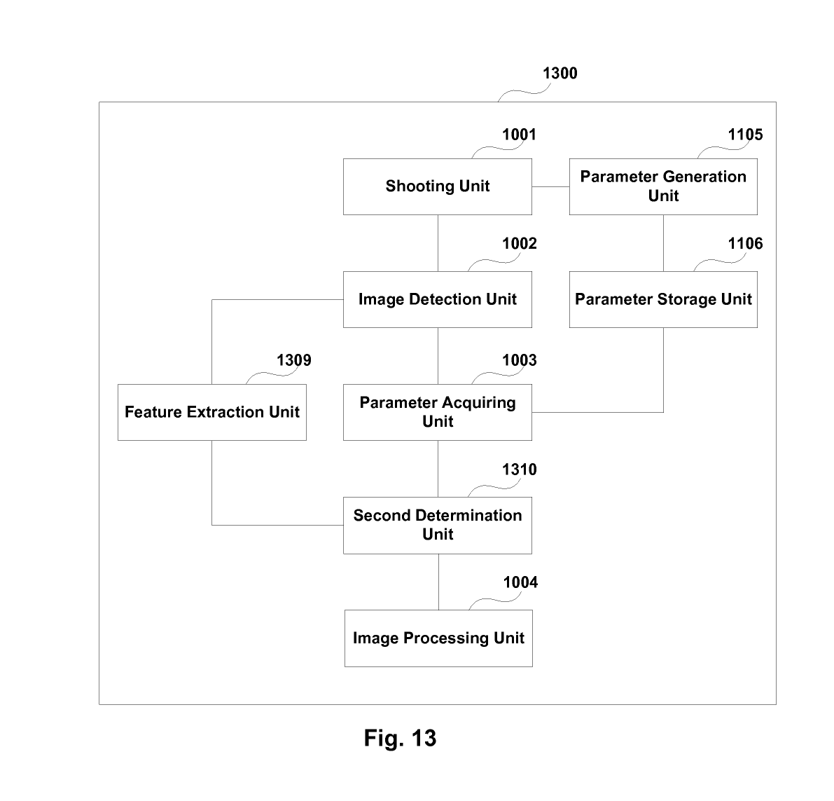

FIG. 13 is another structure diagram (or system diagram) of an image processing apparatus according to an embodiment of the present invention. As illustrated in FIG. 13, the image processing apparatus 1300 includes a shooting unit 1001, an image detection unit 1002, a parameter acquiring unit 1003, an image processing unit 1004, a parameter generation unit 1105 and a parameter storage unit 1106, as described above.

As illustrated in FIG. 13, the image processing apparatus 1300 may further include a feature extraction unit 1309 and a second determination unit 1310, wherein the feature extraction unit 1309 extracts feature information of the shot object, and the second determination unit 1310 determines image processing parameters for image processing according to the extracted feature information and the acquired image processing parameters. In addition, the image processing unit 1004 is further configured to perform an image processing of the acquired image according to the image processing parameters determined by the second determination unit 1310.

In this embodiment, the feature information of the shot object may include one or arbitrary combinations of hair style of the shot object, accessory of the shot object, scenario where the shot object is located, expression of the shot object, gesture of the shot object and clothing of the shot object.

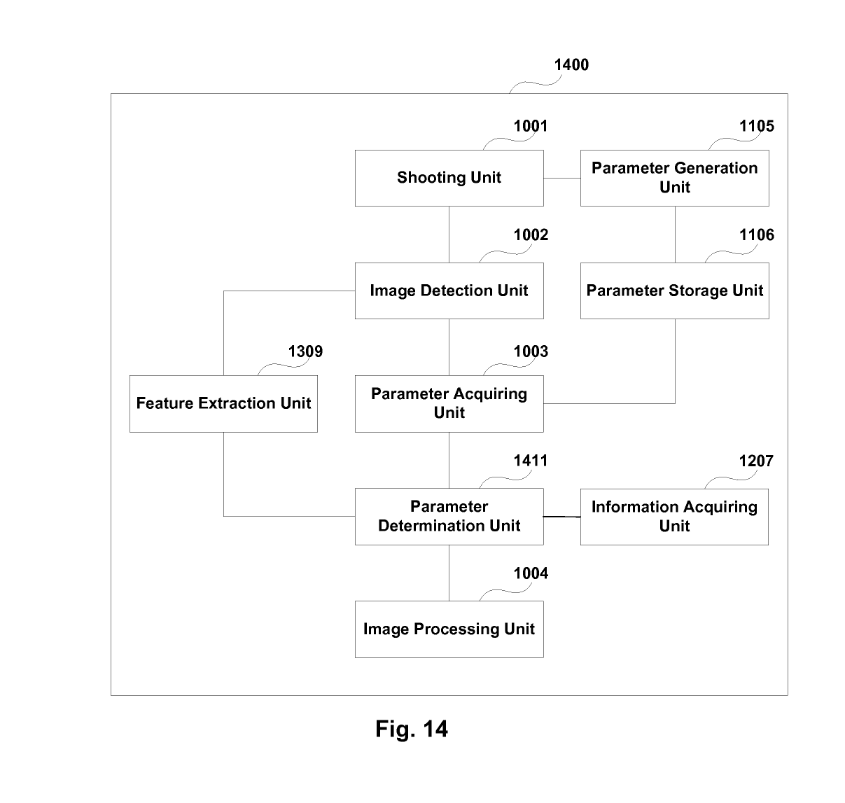

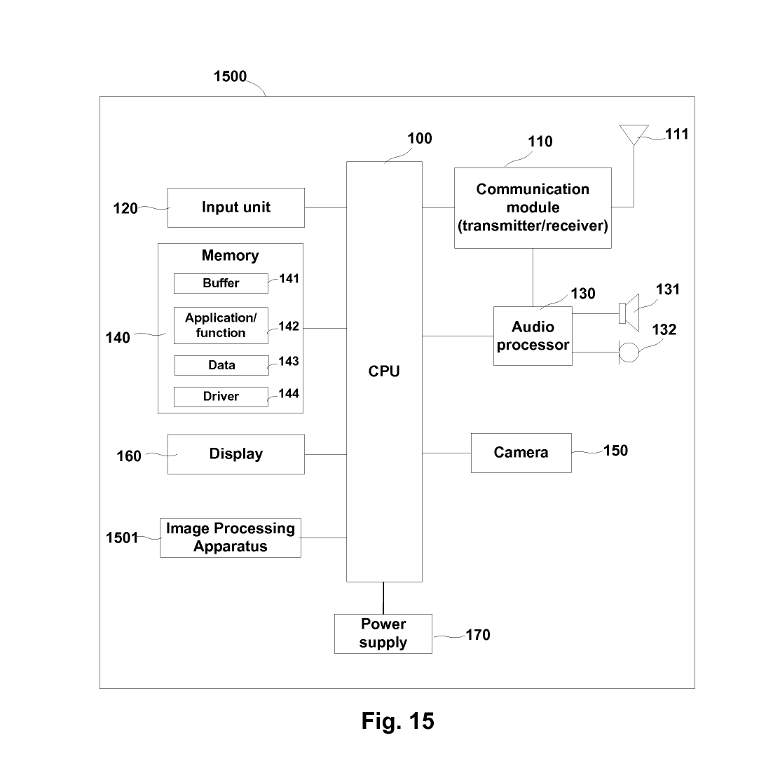

FIG. 14 is another structure diagram (or system diagram) of an image processing apparatus according to Embodiment 4 of the present invention. As illustrated in FIG. 14, the image processing apparatus 1400 includes a shooting unit 1001, an image detection unit 1002, a parameter acquiring unit 1003, an image processing unit 1004, a parameter generation unit 1105 and a parameter storage unit 1106, as described above.

In addition, the image processing apparatus 1400 may further include an information acquiring unit 1207, a parameter determination unit 1411 and a feature extraction unit 1309, where the parameter determination unit 1411 determines image processing parameters for image processing according to the information related to the image, the extracted feature information and the acquired image processing parameters. In addition, the image processing unit 1004 is further configured to perform an image processing of the acquired image according to the image processing parameters determined by the parameter determination unit 1411.

As can be seen from the above embodiment, various personalized needs of the user can be met and better user experiences can be obtained by acquiring, during a shooting, image processing parameters corresponding to the shot object and pre-stored according to the user's operation, and performing an image processing of the acquired image according to the image processing parameters corresponding to the shot object.

### Embodiment 5

The embodiment of the present invention provides an electronic device, including the image processing apparatus according to Embodiment 3 or 4.

In this embodiment, the electronic device may be a mobile terminal for shooting a shot object, and the shot object may be one or more faces or portraits. But the present invention is not limited thereto, and the electronic device may be other device such as computer device, while the shot object may be other object such as other portion of the human body.

FIG. 15 is a block diagram of a system structure of a mobile terminal 1500 according to the embodiment of the present invention, including an image processing apparatus 1501, which may be the image processing apparatus 1000 according to Embodiment 3, or the image processing apparatus 1100, 1200, 1300 or 1400 according to Embodiment 4.

As illustrated in FIG. 15, the image processing apparatus 1501 may be connected to a Central Processing Unit (CPU) 100. To be noted, the diagram is schematic, and other type of structure may be used to supplement or replace the structure, so as to realize the telecom function or other function.

As illustrated in FIG. 15, the mobile terminal 1500 may further include a CPU 100, a communication module 110, an input unit 120, an audio processing unit 130, a memory 140, a camera 150, a display 160 and a power supply 170.

The CPU 100 (sometimes also referred to as controller or operation control, including microprocessor or other processor unit and/or logic unit) receives an input and controls respective parts and the operation of the mobile terminal 1500. The input unit 120 provides an input to the CPU 100. The input unit 120 for example is a key or a touch input unit. The camera 150 acquires image data and provides the acquired image data to the CPU 100 for a conventional usage, such as storage, transmission, etc.

The power supply 170 supplies electric power to the mobile terminal 1500. The display 160 displays an object to be displayed, such as image and text. The display 160 for example may be an LCD display, but not limited thereto.

The memory 140 is coupled to the CPU 100. The memory 140 may be a solid-state memory such as Read Only Memory (ROM), Random Access Memory (RAM), Subscriber Identity Module (SIM) card, etc. It may also be such a memory which stores information even if the power is off, and which can be selectively erased and provided with more data. The example of the memory sometimes is referred to as EPROM. The memory 140 may also be other type of device. The memory 140 includes a buffer memory 141 (sometimes referred to as buffer). The memory 140 may include an application/function storage section 142 configured to store application programs and function programs, or to perform procedures of the operation of the mobile terminal 1500 through the CPU 100.

The memory 140 may further include a data storage section 143 configured to store data such as contact, digital data, picture, sound and/or any other data used by the electronic device. A drive program storage section 144 of the memory 140 may include various drive programs of the electronic device for performing the communication function and/or other functions (e.g., message transfer application, address book application, etc.) of the electronic device.

The communication module 110 is a transmitter/receiver 110 which transmits and receives signals via an antenna 111. The communication module (transmitter/receiver) 110 is coupled to the CPU 100, so as to provide an input signal and receive an output signal, which may be the same as the situation of conventional mobile communication terminal.

Based on different communication technologies, the same electronic device may be provided with a plurality of communication modules 110, such as cellular network module, Bluetooth module and/or wireless local area network (WLAN) module. The communication module (transmitter/receiver) 110 is further coupled to a speaker 131 and a microphone 132 via an audio processor 130, so as to provide an audio output via the speaker 131, and receive an audio input from the microphone 132, thereby performing the normal telecom function. The audio processor 130 may include any suitable buffer, decoder, amplifier, etc. In addition, the audio processor 130 is further coupled to the CPU 100, so as to locally record sound through the microphone 132, and play the locally stored sound through the speaker 131.

The embodiment of the present invention also provides a computer readable program, which when being executed in the electronic device, enables a computer to perform the image processing method according to Embodiment 1 or 2 in the electronic device.

The embodiment of the present invention further provides a storage medium which stores a computer readable program, wherein the computer readable program enables a computer to perform the image processing method according to Embodiment 1 or 2 in the electronic device.

The preferred embodiments of the present invention are described as above with reference to the drawings. Many features and advantages of those embodiments are apparent from the detailed Specification, thus the accompanied claims intend to cover all such features and advantages of those embodiments which fall within the spirit and scope thereof. In addition, since numerous modifications and changes may be easily conceivable to a person skilled in the art, the embodiments of the present invention are not limited to the exact structure and operation as illustrated and described, but cover all suitable modifications and equivalents falling within the scope thereof.

It shall be understood that each of the parts of the present invention may be implemented by hardware, software, firmware, or combinations thereof. In the above embodiments, multiple steps or methods may be implemented by software or firmware that is stored in the memory and executed by an appropriate instruction executing system. For example, if the implementation uses hardware, it may be realized by any one of the following technologies known in the art or a combination thereof as in another embodiment: a discrete logic circuit having a logic gate circuit for realizing logic functions of data signals, application-specific integrated circuit having an appropriate combined logic gate circuit, a programmable gate array (PGA), and a field programmable gate array (FPGA), etc.

The description or blocks in the flowcharts or of any process or method in other manners may be understood as being indicative of including one or more modules, segments or parts for realizing the codes of executable instructions of the steps in specific logic functions or processes, and that the scope of the preferred embodiments of the present invention include other implementations, wherein the functions may be executed in manners different from those shown or discussed, including executing the functions according to the related functions in a substantially simultaneous manner or in a reverse order, which shall be understood by a person skilled in the art to which the present invention pertains.

The logic and/or steps shown in the flowcharts or described in other manners here may be, for example, understood as a sequencing list of executable instructions for realizing logic functions, which may be implemented in any computer readable medium, for use by an instruction executing system, apparatus or device (such as a system based on a computer, a system including a processor, or other systems capable of extracting instructions from an instruction executing system, apparatus or device and executing the instructions), or for use in combination with the instruction executing system, apparatus or device.

The above literal description and drawings show various features of the present invention. It shall be understood that a person of ordinary skill in the art may prepare suitable computer codes to carry out each of the steps and processes described above and illustrated in the drawings. It shall also be understood that the above-described terminals, computers, servers, and networks, etc. may be any type, and the computer codes may be prepared according to the disclosure contained herein to carry out the present invention by using the apparatuses.

Specific embodiments of the present invention have been disclosed herein. Those skilled in the art will readily recognize that the present invention is applicable in other environments. In practice, there exist many embodiments and implementations. The appended claims are by no means intended to limit the scope of the present invention to the above particular embodiments. Furthermore, any reference to “an apparatus configured to . . . ” is an explanation of apparatus plus function for describing elements and claims, and it is not desired that any element using no reference to “an apparatus configured to . . . ” is understood as an element of apparatus plus function, even though the wording of “apparatus” is included in that claim.

Although a particular preferred embodiment or embodiments have been shown and the present invention has been described, it is evident that equivalent modifications and variants are conceivable to a person skilled in the art in reading and understanding the description and drawings. Especially for various functions executed by the above elements (portions, assemblies, apparatus, and compositions, etc.), except otherwise specified, it is desirable that the terms (including the reference to “apparatus”) describing these elements correspond to any element executing particular functions of these elements (i.e. functional equivalents), even though the element is different from that executing the function of an exemplary embodiment or embodiments illustrated in the present invention with respect to structure. Furthermore, although the a particular feature of the present invention is described with respect to only one or more of the illustrated embodiments, such a feature may be combined with one or more other features of other embodiments as desired and in consideration of advantageous aspects of any given or particular application.

1. An image processing method, comprising:
acquiring an image containing a shot object with a shooting part;
performing an image recognition of the acquired image to detect the shot object;
acquiring image processing parameters of the detected shot object, wherein the image processing parameters are pre-stored according to the user's operation; and
performing an image processing of the acquired image according to the image processing parameters of the shot object.

2. The image processing method according to claim 1, further comprising:
generating the image processing parameters of the shot object according to the user's operation; and
storing the image processing parameters and an identifier of the shot object accordingly.

3. The image processing method according to claim 1, wherein the shot object being one or more portraits, or one or more objects.

4. The image processing method according to claim 1, wherein the image processing parameter comprises one or arbitrary combinations of image brightness parameter, image chromaticity parameter, image saturation parameter, image white balance parameter, image de-noising processing parameter, feature removal or addition parameter, special effect processing parameter and edge enhancement processing parameter.

5. The image processing method according to claim 1, further comprising:
acquiring information related to the image; and
determining image processing parameters for image processing according to the information related to the image and the acquired image processing parameters.

6. The image processing method according to claim 5, wherein the information related to the image comprises one or arbitrary combinations of time information, weather information, shooting spot information, user information and history information.

7. The image processing method according to claim 1, further comprising:
extracting feature information of the shot object; and
determining image processing parameters for image processing according to the extracted feature information and the acquired image processing parameters.

8. The image processing method according to claim 7, wherein the feature information of the shot object comprises one or arbitrary combinations of hair style of the shot object, accessory of the shot object, scenario where the shot object is located, expression of the shot object, gesture of the shot object, clothing of the shot object, position of the shot object in the image, facial features of the shot object, skin color of the shot object and stature of the shot object.

9. The image processing method according to claim 1, further comprising:
acquiring information related to the image, and extracting feature information of the shot object; and
determining image processing parameters for image processing according to the information related to the image, the extracted feature information and the acquired image processing parameters.

10. An image processing apparatus, comprising:
a shooting unit, configured to acquire an image containing a shot object with a shooting part;
an image detection unit, configured to perform an image recognition of the acquired image to detect the shot object;
a parameter acquiring unit, configured to acquire image processing parameters of the detected shot object, wherein the image processing parameters are pre-stored according to the user's operation; and
an image processing unit, configured to perform an image processing of the acquired image according to the image processing parameters of the shot object.

11. The image processing apparatus according to claim 10, further comprising:
a parameter generation unit, configured to generate the image processing parameters of the shot object according to the user's operation; and
a parameter storage unit, configured to store the image processing parameters and an identifier of the shot object accordingly.

12. The image processing apparatus according to claim 10, further comprising:
an information acquiring unit, configured to acquire information related to the image; and
a first determination unit, configured to determines image processing parameters for image processing according to the information related to the image and the acquired image processing parameters.

13. The image processing apparatus according to claim 10, further comprising:
a feature extraction unit, configured to extract feature information of the shot object; and
a second determination unit, configured to determine image processing parameters for image processing according to the extracted feature information and the acquired image processing parameters.

14. The image processing apparatus according to claim 10, further comprising:
an information acquiring unit, configured to acquire information related to the image;
a feature extraction unit, configured to extract feature information of the shot object; and
a parameter determination unit, configured to determine image processing parameters for image processing according to the information related to the image, the extracted feature information and the acquired image processing parameters.

15. An electronic device, comprising the image processing apparatus of claim 10.

16. The electronic device according to claim 15, wherein the electronic device is a mobile terminal which shoots a shot object, the shot object being one or more portraits, or one or more objects.

17. An electronic device, comprising the image processing apparatus of claim 11, and wherein the electronic device is a mobile terminal which shoots a shot object, the shot object being one or more portraits, or one or more objects.

18. An electronic device, comprising the image processing apparatus of claim 12, and wherein the electronic device is a mobile terminal which shoots a shot object, the shot object being one or more portraits, or one or more objects.

19. An electronic device, comprising the image processing apparatus of claim 13, and wherein the electronic device is a mobile terminal which shoots a shot object, the shot object being one or more portraits, or one or more objects.

20. An electronic device, comprising the image processing apparatus of claim 14, and wherein the electronic device is a mobile terminal which shoots a shot object, the shot object being one or more portraits, or one or more objects.
